(19) United States
(12) Patent Application Publication
(10) Pub. No.: US 2021/0269079 A1
(43) Pub. Date: Sep. 2, 2021

(54) Cable operated disc brakes for vehicles

(71) Applicant: Simeon Mazelin Troyer, Rich Hill, MO (US)

(72) Inventor: Simeon Mazelin Troyer, Rich Hill, MO (US)

(21) Appl. No.: 16/873,201

(22) Filed: Feb. 27, 2020

(51) Int. Cl. B62C 7/00; F16D 65/18; F16D 55/2255

(52) U.S. Cl. CPC B62C 7/00; F16D 2121/14; F16D 55/2255; F16D 65/183

(57) ABSTRACT

A disc brake that can be operated via cable, for reliable use such as emergency brakes.

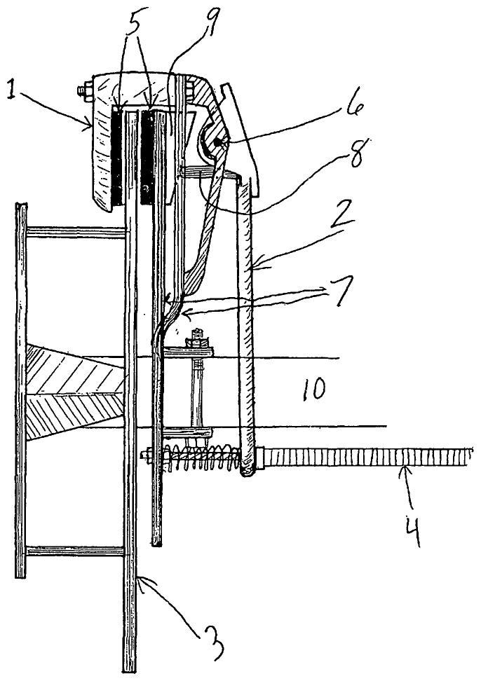

### BACKGROUND OF THE INVENTION

To create a cable operated disc brake for horsedrawn vehicles, that would not lock or freeze up.

### BRIEF SUMMARY OF THE INVENTION

The brakepad on these brakes are mounted on steel or other springlike material which flexes to engage the brakes when pressure is applied to the calipers.

### BRIEF DESCRIPTION OF THE DRAWING

(1) shows a cast aluminum piece to which is glued a piece of brake liner.

(2) shows a lever to which the cable is attached.

(3). SHOWS the disc (or rotor).

(4) shows the cable casing, which pushes the lever.

(5) shows two pieces of brake liner.

(6) shows the lever's pivot point.

(7) shows the opproximate spots that flex to allow caliper movement.

(8) shows the bar that applies pressure to the calipers.

(9) shows the wedge that drops in to keep the calipers closely set.

(10) shows the axle of the vehicle.

### DETAILED DESCRIPTION OF THE INVENTION

Pressure is applied to cable casing, which pushes the lever, which applies pressure to both brakepads. This apparatus can be manufactured of sheet steel, cast steel, or other flexable material.

It can be laser cut steel, cast steel, or a molded material.

It can include a wedge, #(9) or set screw to adjust calipers.

The claimed invention is:

1. A disc brake for vehicles, which allows its calipers to move, (such as to engage, or disengage) only by means of the flexibility of the material, (to which is mounted the brakepad, (or any other material which creates friction) when pressure is applied to the calipers.
